(19) United States
(12) Patent Application Publication
(10) Pub. No.: US 2009/0170472 A1
(43) Pub. Date: Jul. 2, 2009

(54) SHARED NETWORK INFRASTRUCTURE

(76) Inventors: John M. Chapin, Arlington, MA (US); Steve Muir, Cambridge, MA (US); Jeffrey Steinheider, Arlington, MA (US)

Correspondence Address: FISH & RICHARDSON PC, P.O. BOX 1022, MINNEAPOLIS, MN, 55440-1022, US

(21) Appl. No.: 12/243,846

(22) Filed: Oct. 1, 2008

Related U.S. Application Data
(60) Provisional application No. 61/017,503, filed on Dec. 28, 2007.

(51) Int. Cl. H04M 1/66

(52) U.S. Cl. 455/410

(57) ABSTRACT

Two or more communications applications are executed on a shared processing platform to process signals received from and transmitted to wireless devices according to a communications protocol, the shared processing platform having shared hardware resources including memory and at least one data processor. A security mechanism is provided to enable each communications application to have independent control of access to data and configuration settings that are private to the communications application. Compatibility of hardware configuration settings associated with different communications applications is determined, and conflicts between hardware configuration settings associated with different communications applications are mediated.

### RELATED APPLICATION

This application claims priority to U.S. Patent Application No. 61/017,503, titled “Shared Network Infrastructure”, filed on Dec. 28, 2007. The above application is incorporated herein by reference.

### BACKGROUND

This description is related to a shared network infrastructure.

After several years of successful growth, wireless networks have covered large territories where the revenue generated from population densities and the wealth of the relevant populations is sufficient to support the cost of acquiring and operating such networks. However, as much as two-thirds of the world's population does not have service from wireless networks due to the difficulty in recovering the costs of acquiring and operating the networks through charging for services. This is especially true in areas where low population density or low income limit the revenue potential of a proposed network site. While telecommunications manufacturers have made significant progress over the years in reducing the prices of acquiring and operating wireless networks, these costs still limit the deployment of wireless networks.

Although wireless networks are both expensive to acquire and expensive to operate, the former cost could be taken care of through a subsidy. Indeed, several governments, through their telecommunications regulatory authorities, have taken measures to subsidize construction of networks in rural locations. Even with subsidies to acquire networks, carriers are slow to deploy in rural areas. This shows that a solution that reduces the capital cost of deploying a network, but not the operating cost, will have limited impact on extending the reach of networks to low revenue potential areas. Failure to address operating expenses and, to a lesser degree, capital expenses, associated with deploying and operating a network will limit future growth of wireless networks.

One way to reduce the costs of deploying and operating wireless communications systems is to split those costs among several carriers by sharing the network. There are several different ways in which carriers may share a network. To begin with, networks can be divided into active and passive components. Active components are those that consume power during their regular operation (such as baseband processing of signals and power amplification). Passive components generally do not consume power and would include things such as antennas, towers or shelters. For several years, carriers have commonly shared passive components. However, the gains to be had by sharing passive components are limited. These limits are largely the result of the fact that the operation expense associated with passive components tends to be lower. Passive components, once put in place, tend to be a sunk cost and generally have a smaller impact on the operational expenses of a carrier (the most notable exception being leasing tower and shelter space, where carriers opt to do that rather than acquiring their own towers). As a result, any network sharing solution that is going to have the maximum impact on deployment of networks in revenue limited areas should address sharing of active components in addition to passive components.

There are several models carriers have followed when looking at sharing of active network components. Roaming arrangements are a form of sharing in which one carrier builds a network and a subsequent carrier, rather than building a network, arranges for the first carrier to carry traffic for the subscribers of the second carrier, frequently for a fee based on the minutes of traffic carried.

Another model is for carriers to share ownership (for example, through a joint venture) in a network that transmits a channel or channels used by both of the carriers and a new, shared network ID. In this model, subscribers for each carrier will be carried on the shared network and each mobile phone should recognize the network as “its own” and display appropriate logos and messaging on its display. Each carrier's traffic will be able to use any of the channels transmitted by the network, regardless of whose spectrum those transmissions use.

A third model is for carriers to share infrastructure with the exception of the line cards used to receive and transmit a channel. These line cards would be hosted within a common chassis or other enclosure(s), but would be tuned to different channels, allowing each carrier to transmit on its own spectrum, with its usual (unshared) network ID, but would require the carriers to use similar equipment from the same vendors.

Pursuit of active sharing arrangements is complicated by business and technical requirements of carriers as well as regulatory and competitive requirements of local governments. To begin with, most carriers tend to care deeply about the experience their subscribers have while on the carrier's network. For example, for several carriers, a sharing arrangement may not be possible if the subscriber's mobile phone did not display the carrier's logo, trademarks or other forms of identity when attached to the shared network. Similarly, carriers may be mistrustful of technical differences in networks because the carriers have several performance indicators that they use to ensure a sufficient and consistent level of service for their subscribers. Many carriers have incrementally improved the ability of their networks to fulfill these performance indicators over the course of several years, through experimentation with and tuning of network parameters. To the extent sharing involves changes in these settings, many carriers may not permit sharing or may resist it. Even if the resistance is limited to certain groups within a carrier (for example, network operations), this resistance can be fatal to a proposed sharing arrangement.

In addition to internal concerns within the carrier, external constituencies may also be concerned with sharing arrangements. To begin with, it is quite common for sovereign spectrum regulators to grant rights to use a particular block of spectrum only to a particular entity and may further preclude transfer of those rights. To the extent a network sharing method implies spectrum sharing, it may be prohibited by such a regulation.

Sovereign governments may also be concerned with the competitive impact of network sharing. To the extent a network sharing technique requires those carriers sharing the network to align their technology roadmaps, the opportunity for the carriers to differentiate themselves on pricing and level of service may be diminished or eliminated. As noted above, this technology alignment may be extensive since the networks may literally be identical (in the roaming and “shared channel” models). Even in the shared chassis model, there is limited opportunity for either carrier to differentiate their services because while the line cards may be separate, the vendor from which those cards were acquired, the network controller for the cards, and the chassis in which the cards reside may all be the same. These factors limit the ability of the carrier to modify the cards, the features supported by the cards and the settings of the network.

Finally, the communications standards employed by carriers also present a significant barrier to active sharing arrangements. Several carriers use different, incompatible communications standards in their networks. Even if carriers use the same communications standards today, a network sharing arrangement may necessitate an alignment of future technology roadmaps. This alignment may have to occur not only with respect to what standards will be used in the future, but also as to when those evolutions will take place.

Due to the fundamental importance of standards choices, carriers cannot ignore this issue when contemplating a sharing arrangement. On the other hand, addressing these issues is difficult because the information required to be shared is very sensitive. That information includes not only the technology choices being made, but also intimate details of network configuration from which planned support for data rates and subscriber uptake may be derived. This extremely sensitive data is normally guarded carefully by carriers. Exchange of such data also poses significant regulatory concerns.

### SUMMARY

In general, in one aspect, two or more communications applications are executed on a shared processing platform to process signals received from and transmitted to wireless devices according to a communications protocol, the shared processing platform having shared hardware resources including memory and at least one data processor; a security mechanism is provided to enable each communications application to have independent control of access to data and configuration settings that are private to the communications application; compatibility of hardware configuration settings associated with different communications applications is determined; and conflicts between hardware configuration settings associated with different communications applications are mediated.

Implementations can include one or more of the following features. A virtualization application is executed to provide two or more virtual machines in which the two or more communications applications execute, the virtualization application providing the security mechanism to enable independent control of access to data and configuration settings by the communications applications executing in the two or more virtual machines. A local call from a first wireless device is connected to a second wireless device through at least one virtual machine without routing the call to a central switching facility that processes calls in addition to calls processed by the virtual machines. Connecting the call includes at a first virtual machine, processing a call from the first wireless device, routing the call to a second virtual machine, and at the second virtual machine, connecting to the second wireless device to complete connection of the call. At each virtual machine, the shared hardware resources are accessed to perform at least one of physical, link, network, transport, session, and presentation layer processing functions for communicating with the wireless devices according to one or more communications protocols. A virtual base station is executed on each virtual machine. Virtual base station controllers are executed to control corresponding virtual base stations. Information is transferred between the virtual base station and the virtual base station controller through a virtual private network established over a backhaul link shared by more than one carrier. The communications applications are used to access shared hardware resources and perform input/output operations in a manner that is the same as if the communications applications were not executing on the virtual machine. Executing two or more communications applications on the shared processing platform includes executing paravirtualized versions of the two or more communications applications to access shared hardware resources and perform input/output operations by issuing function calls to a virtualization infrastructure in a manner that is different than if the communications applications were not executing on the virtual machines. Signals are processed at different virtual machines using different communications protocols.

Changes to configuration settings associated with one communications application are prevented from affecting configuration settings associated with other communications applications. Compatibility of capacity utilization associated with different communications applications are determined, conflicts between capacity utilization associated with different communications applications are mediated. A supervisor application is executed to monitor configuration settings associated with the communications applications. Reports are selectively sent from the supervisor application to at least one of the carriers of the communications applications and a host who maintains hardware for supporting the operating system. A report is sent from the supervisor application to a particular carrier or selected carriers that are less than all carriers. A report is sent from the supervisor application to the host but not the carriers. A first communications application executing on the shared processing platform is prevented from accessing a hardware resource if accessing the hardware resource by the first communications application results in a conflict with other communications applications executing on the shared processing platform. Two communications applications are configured to use different frequency bands when communicating with the wireless devices. At least one of a power amplifier, a wideband radio frequency front end, a duplexer and diversity filter and an antenna are shared among different communications applications. A local call from a first wireless device is connected to a second wireless device through at least one communications application without routing the call to a central switching facility that processes calls in addition to calls processed by the communications applications. Connecting the call includes at a first communications application, processing a call from the first wireless device, routing the call to a second communications application, and at the second communications application, connecting to the second wireless device to complete connection of the call.

An instruction to reconfigure a first communications application executing on the shared processing platform is received, and a determination is made as to whether executing the instruction to reconfigure the first communications application will generate a conflict with other communications applications executing on the shared processing platform or generate a conflict with capacity rights granted to a carrier executing the first communications application. Receiving an instruction to reconfigure the first communications application includes receiving an instruction to modifying a number of channels allocated to the communications protocol associated with the first communications application. Executing a communications application includes executing a communications application to process the signals received from and transmitted to wireless devices according to at least one of GSM, AMPS, CDMA, EDGE, UMTS, WiMAX, LTE, and WCDMA communications protocol. The communications application accesses shared hardware resources and performs input/output operations through a supervisor agent that mediates access to the shared hardware resources by the communications applications. The supervisor agent mediates a configuration request from a carrier operational support systems (OSS) to the communications application. The supervisor agent mediates requests for resources on a first-come, first-served, preferential priority, or other dynamic basis.

In general, in another aspect, a system includes a shared processing platform having hardware resources including memory and at least one data processor; communications applications that are executed on the shared processing platform to process signals received from and transmitted to wireless devices according to a communications protocol; and an operating system that supports execution of the communications applications and provides a security mechanism to enable each communications application to have independent control of access to data and configuration settings that are private to the communications application.

Implementations can include one or more of the following features. The operating system supports execution of a virtualization application to provide two or more virtual machines in which the two or more communications applications execute, the virtual machines sharing the hardware resources, the virtualization application providing the security mechanism to enable independent control of access to data and configuration settings by the communications applications executing in the two or more virtual machines. A supervisor determines whether executing an instruction to reconfigure a virtual machine will generate a conflict with other virtual machines. Two communications applications executing on different virtual machines use different frequency bands when communicating with the wireless devices. Two communications applications executing on different virtual machines process signals using different communications protocols. The communications applications access the hardware resources and perform input/output operations in a manner that is the same as if the communications applications were not executing on the virtual machines. The communications applications include paravirtualized versions of the communications applications that access the hardware resources and perform input/output operations by issuing function calls to a virtualization infrastructure in a manner that is different than if the communications applications were not executing on the virtual machines.

A supervisor determines compatibility of hardware configuration settings associated with different communications applications. The supervisor prevents changes to configuration settings associated with one communications application from affecting configuration settings associated with other communications applications. The supervisor prevents a communications application from accessing a hardware resource if accessing the hardware resource by the first communications application results in a conflict with other communications applications. The supervisor determines whether modifying a number of channels allocated to the communications protocol associated with a communications application will generate a conflict with other communications applications. At least one of a power amplifier, a wideband radio frequency front end, and an antenna is shared among different virtual machines. The operating system provides interfaces to allow the communications applications to access the shared hardware resources. The communications applications are configured to route local calls from a first wireless device to a second wireless device without routing the call to a central switching facility that processes calls in addition to the calls processed by the communications applications. The communications protocol includes at least one of GSM, AMPS, CDMA, EDGE, UMTS, WiMAX, LTE, and WCDMA.

Each communications application accesses the shared hardware resources to perform at least one of physical, link, network, transport, session, and presentation layer processing functions for communicating with the wireless devices according to one or more communications protocols. The communications applications include virtual base stations. The system includes virtual base station controllers to control corresponding virtual base stations. The virtual base station controllers are located at the same location as the virtual base stations and route local calls from a first wireless device to a second wireless device without routing the call to a central switching facility. The system includes a virtual private network endpoint of a virtual private network established over a backhaul link shared by more than one carrier, in which the virtual base station communicates with a virtual base station controller through the virtual private network. The communications application access the hardware resources and perform input/output operations through a supervisor agent that mediates access to the shared hardware resources by the communications applications.

In general, in another aspect, an apparatus includes a shared processing platform for executing two or more communications applications, the shared processing platform having shared hardware resources including memory and at least one data processor to process signals received from and transmitted to wireless devices according to a communications protocol; means for providing a security mechanism to enable each communications application to have independent control of access to data and configuration settings that are private to the communications application; and means for determining compatibility of and mediating conflicts between hardware configuration settings associated with different communications applications.

In general, in another aspect, a virtualization application is executed on an operating system to provide two or more virtual machines that share hardware resources including memory and at least one data processor, each virtual machine being configured independently of other virtual machines. The virtualization application provides a security mechanism to enable each virtual machine to have independent control of access to data and configuration settings that are private to the virtual machine. A communications application is executed on each virtual machine to process signals received from and transmitted to wireless devices according to a communications protocol. Compatibility of hardware configuration settings associated with different virtual machines is determined.

Implementations can include one or more of the following features. Changes to configuration settings associated with one virtual machine are prevented from affecting configuration settings associated with other virtual machines. A first communications application executing on a first virtual machine is prevented from accessing a hardware resource if accessing the hardware resource by the first communications application results in a conflict with other communications applications executing on other virtual machines.

Two virtual machines can be configured to use different frequency bands when communicating with the wireless devices. A power amplifier, a wideband radio frequency front end, and/or an antenna can be shared among various virtual machines. Signals can be processed at various virtual machines using different communications protocols. A local call from a first wireless device to a second wireless device can be connected through at least one virtual machine without routing the call to a central switching facility that processes calls in addition to the calls processed by the virtual machines. Connecting the call can include, at a first virtual machine, processing a call from the first wireless device, routing the call to a second virtual machine, and at the second virtual machine, connecting to the second wireless device to complete connection of the call.

An instruction to reconfigure a virtual machine is received, and whether executing the instruction to reconfigure the virtual machine will generate a conflict with other virtual machines is determined. Receiving an instruction to reconfigure a virtual machine can include receiving an instruction to modifying a number of channels allocated to the communications protocol associated with the virtual machine. Executing a communications application can include executing a communications application to process the signals received from and transmitted to wireless devices according to at least one of GSM, AMPS, CDMA, EDGE, UMTS, WiMAX, LTE, and WCDMA communications protocol. At each virtual machine, the shared hardware resources can be accessed to perform physical, link, network, transport, session, and/or presentation layer processing functions for communicating with the wireless devices according to one or more communications protocols.

Executing a communications application on each virtual machine can include executing a virtual base station on each virtual machine. Virtual base station controllers can be executed to control corresponding virtual base stations. Information can be transferred between the virtual base station and the virtual base station controller through a virtual private network established over a backhaul link shared by more than one carrier. In some examples, the communications application can access shared hardware resources and perform input/output operations in a manner that is the same as if the communications application were not executing on the virtual machine. In some examples, the communications application can access shared hardware resources and perform input/output operations by issuing function calls to a virtualization infrastructure in a manner that is different than if the communications application were not executing on the virtual machine. In some examples, the communications application can access shared hardware resources and perform input/output operations through a supervisor agent that mediates access to the shared hardware resources by the communications applications.

In general, in another aspect, a shared network infrastructure includes hardware resources, an operating system, and a supervisor. The hardware resources include memory and at least one data processor. The operating system supports execution of a virtualization application to provide virtual machines and a security mechanism to enable each virtual machine to have independent control of access to data and configuration settings that are executed within the virtual machine. Two or more virtual machines are provided by the virtualization application, in which the virtual machines share the hardware resources, each virtual machine being configured independently of other virtual machines. Communications applications are each executed on one of the virtual machines to process signals received from and transmitted to wireless devices according to a communications protocol. The supervisor determines compatibility of hardware configuration settings associated with different virtual machines.

Implementations can include one or more of the following features. The supervisor can prevent changes to configuration settings associated with one virtual machine from affecting configuration settings associated with other virtual machines. The supervisor can prevent a communications application executing on a first virtual machine from accessing a hardware resource if accessing the hardware resource by the first communications application results in a conflict with other communications applications executing on other virtual machines. Two virtual machines can use different frequency bands when communicating with the wireless devices. A power amplifier, a wideband radio frequency front end, and/or an antenna can be hardware resources that are shared among different virtual machines. Two virtual machines can process signals using the same or different communications protocols, which may use different sampling rates. The operating system can provide interfaces to allow the virtual machines to access the shared hardware resources.

The virtual machines can be configured to route local calls from a first wireless device to a second wireless device without routing the call to a central switching facility that processes calls in addition to the calls processed by the virtual machines. The supervisor can determine whether executing an instruction to reconfigure a virtual machine will generate a conflict with other virtual machines. The supervisor can determine whether modifying a number of channels allocated to the communications protocol associated with the virtual machine will generate a conflict with other virtual machines. The communications protocol can include GSM, AMPS, CDMA, EDGE, UMTS, WiMAX, LTE, and WCDMA. Each virtual machine can access the shared hardware resources to perform physical, link, network, transport, session, and/or presentation layer processing functions for communicating with the wireless devices according to one or more communications protocols.

The communications applications can include virtual base stations. Virtual base station controllers can control corresponding virtual base stations. The virtual base station controllers can be located remotely from the virtual base stations. In some examples, the virtual base station controllers can be located at the same location as the virtual base stations and route local calls from a first wireless device to a second wireless device without routing the call to a central switching facility. A virtual private network endpoint of a virtual private network is provided, in which the virtual private network is established over a backhaul link shared by more than one carrier. The virtual base station communicates with the virtual base station controller through the virtual private network.

In some examples, the communications applications access the hardware resources and perform input/output operations in a manner that is the same as if the communications applications were not executing on the virtual machines. In some examples, the communications applications access the hardware resources and perform input/output operations by issuing function calls to a virtualization infrastructure in a manner that is different than if the communications applications were not executing on the virtual machines. In some examples, the communications applications access the hardware resources and perform input/output operations through a supervisor agent that mediates access to the shared hardware resources by the communications applications.

These and other aspects and features, and combinations of them, may be expressed as methods, apparatus, systems, means for performing functions, program products, and in other ways.

Advantages of the aspects and features can include one or more of the following. Resources can be shared among different carriers so the capital and operating expenses for each carrier can be reduced. Lowering the costs can make it profitable to provide cellular service in rural areas. Sharing hardware can reduce sites and antennas in urban centers and sensitive areas. Cellular carriers who have different technology choices or feature roadmaps can share hardware resources, and each carrier can still retain independent control of system configurations. Conflicts among different carriers can be prevented. Security can be enhanced by preventing one carrier from accessing information belonging to other carriers. Each carrier sharing the network can separately configure, operate, maintain, and evolve its portion of the shared network, realizing the cost savings of active sharing without the loss of independence and competitive concerns historically attendant to such sharing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a diagram of an example wireless communication system having a shared active infrastructure.

FIG. 1B is a diagram of example hardware and software of a base station.

FIG. 2 is a diagram of example hardware of a base station.

FIG. 3 is a diagram of example virtual base stations, virtual base station controllers, and operational support systems.

FIG. 4 is a diagram of an example virtual base station and an example RF front end.

FIG. 5 is a diagram showing an example allocation of spectrum.

FIG. 6 is a diagram showing example communication paths between virtual base stations and carriers.

FIG. 7 is a diagram showing an example flat network architecture that includes a local base station controller alongside virtual base stations.

FIG. 8 is a flow diagram of an example process for managing a virtual base station.

FIG. 9 is a flow diagram of an example process for operating a virtual base station.

Like reference symbols in the various drawings indicate like elements.

### DETAILED DESCRIPTION

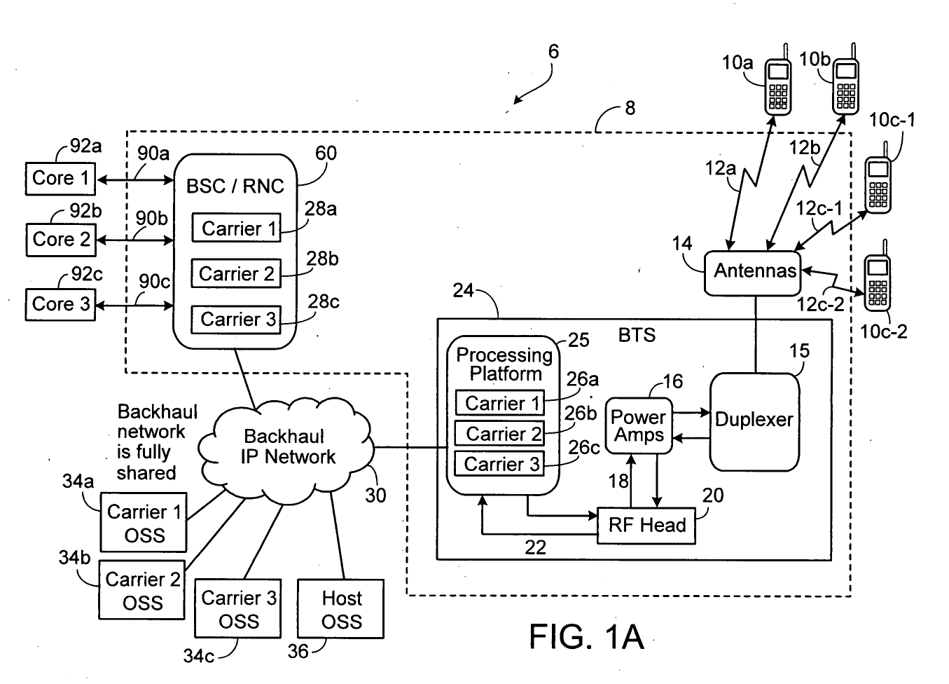

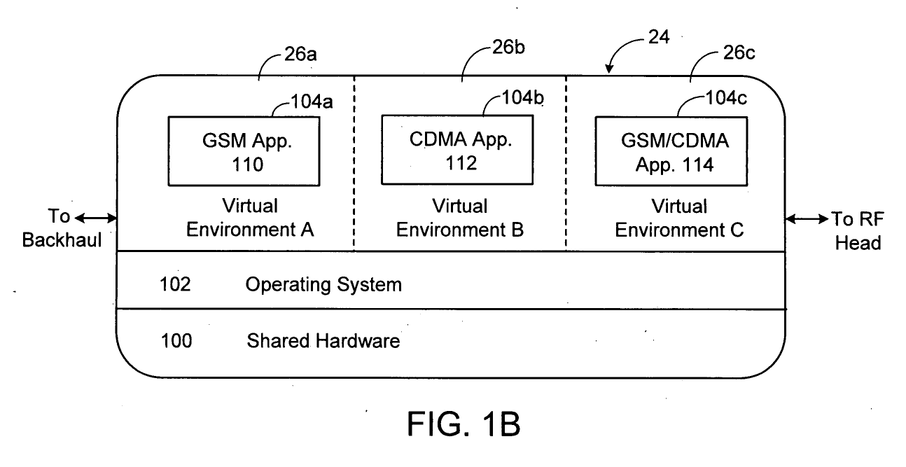

Referring to FIG. 1A, an example wireless communication system 6 includes a shared active infrastructure (SAI) 8 that allows the construction of a single radio access network (RAN) that can support multiple communication standards (e.g., GSM and CDMA) and can be shared by multiple carriers with each carrier having independent management and control of its wireless network. The radio access network includes software radios implemented using a virtualization platform to allow sharing of resources among the carriers.

By sharing a radio access network among standards and carriers, each carrier can decrease the proportion and amount of the capital and operating costs it bears by sharing those costs with other carriers. In this description, the term “carrier” refers to entities that have licenses or other rights to use wireless spectrum to provide voice or data telecommunication services to mobile users. The term “operator” or “host” refers to entities that operate a shared radio access network on behalf of carriers to enable the carriers' customers to receive telecommunications services. Sometimes, the operator can be a carrier. Several costs are decreased by eliminating the redundancy that may occur if each carrier were to build its own network.

The radio access network integrates wireless receivers and transmitters with host computer platforms that include a data access channel, which delivers digital data that is representative of a modulated signal. The radio access network can employ wide band digitization of an incoming signal, such as an RF signal, and allow an application program operating on a general purpose workstation to perform digital signal processing to obtain the information encoded within the digitized signal.

The shared active infrastructure 8 includes a base transceiver station (BTS) 24 that communicates with mobile stations, e.g., 10a, 10b, 10c-1, and 10c-2 (collectively referenced as 10) via radio frequencies, e.g., 12a, 12b, 12c-1, and 12c-2, respectively. The base transceiver station 24 (also referred to as base station 24) includes virtual base transceiver stations (vBTS), e.g., 26a, 26b, and 26c (collectively referenced as 26), that are operated by various carriers, e.g., carrier 1, carrier 2, and carrier 3, respectively, for implementing various communication standards, e.g., Global System for Mobile communications (GSM), Advanced Mobile Phone System (AMPS), code division multiple access (CDMA), Enhanced Data Rates for GSM Evolution (EDGE), Universal Mobile Telecommunications System (UMTS), WiMAX, Long Term Evolution (LTE), and Wideband CDMA (W-CDMA), etc. The base transceiver station 24 includes an RF head 20, power amplifier 16, duplexer 15 and antenna 14 for presenting to a processing platform 25 the digital samples representative of received signals and for accepting for transmission from the processing platform 25 digital samples denoting the signal to be converted to an analog signal and transmitted. Each virtual base station 26 is a software application that implements the functions of a software radio that supports one or more communication standards. The radio frequencies 12a and 12b can be within a block or blocks of radio spectrum licensed to carrier 1 and carrier 2, respectively. The radio frequencies 12c-1 and 12c-2 can be within a block or blocks of radio spectrum licensed to the carrier 3.

The mobile stations 10 can be, e.g., mobile phones or computers equipped with wireless interfaces. The mobile stations are sometimes called mobile terminals or access terminals. Various mobile stations 10 that support different communications standards can communicate with various virtual base stations 26 that are executing on a same physical base station 24.

The shared active infrastructure 8 includes a base station controller or radio network controller (BSC/RNC) 60 that controls various operations of the base station 24. The term “base station controller” is sometimes used in GSM and CDMA standards, whereas the term “radio network controller” is sometimes used in WCDMA standard, thus the term “BSC/RNC” is used in this description to refer to BSC or RNC when the corresponding virtual base station 26 supports GSM or CDMA standard, or the WCDMA standard, respectively. The BSC/RNCs 60 and the base stations 26 can also support other communications standards. The controller BSC/RNC 60 includes virtual BSC/RNCs 28a, 28b, and 28c (collectively referenced as 28) that are operated by carrier 1, carrier 2, and carrier 3, for controlling the operations of the virtual base stations 26a, 26b, and 26c, respectively.

Referring to FIG. 1B, the shared base station 24 includes shared hardware 100 and a shared operating system 102 that support various software applications 104a, 104b, and 104c (collectively referenced as 104). Each software application 104 communicates with the mobile stations 10 using a specified communications protocol and a specified portion of the RF spectrum. Different software applications 104 can support different communications protocols and use different portions of the RF spectrum. Different communications protocols may use different sampling rates. Each application 104 is isolated from the other applications in order to prevent errors in the execution of the application from adversely affecting the other applications executing in the shared computing environment.

The isolation of the software applications 104 may be accomplished through several techniques, including application level virtualization. Application level virtualization affords lower overhead than operating system level virtualization and thus enables more efficient use of computing resources and allocation of more of the resources to processing the relevant protocol signals. The hardware 100 can include one or several servers at one or several locations.

Each of the applications 104 is executed by the base station 24 on behalf of one of several wireless carriers that holds spectrum usage rights at the location of the base station 24. Subscribers of other wireless carriers may receive services at such location via roaming agreements or similar arrangements. Each of the software applications 104 communicates with a corresponding virtual BSC/RNC 28 via a backhaul connection 30.

In general, the term “base station 24” refers to the hardware and software that are used to support multiple instances of the virtual base station 26. The term “virtual base station 26” refers to a virtual machine executing a software application 104 to implement the functions of a base station. The term “virtual BSC/RNC 28” refers to a virtual machine executing software to implement the functions of a base station controller or radio network controller. Each virtual machine can have hardware and software resources that are allocated to the virtual machine. The virtual machines can be updated locally or remotely.

Referring to FIG. 1A, a virtual BSC/RNC 28 can control, e.g., tens or hundreds of virtual base stations 26. The virtual BSC/RNC 28 may allocate radio channels, receive measurements from the mobile stations 10, and control handovers from one base station 26 to another. In some examples, the virtual base station/radio network controller 28 function as hubs by connecting to several virtual base stations 26 through a larger number of low capacity links, and connecting to a mobile switching center through a smaller number of high capacity links.

The wireless communication system 6 includes carrier operational support systems (OSS) 34a, 34b, and 34c (collectively referenced as 34) that are operated by carrier 1, carrier 2, and carrier 3, respectively, for supporting network management and configuration functions. For example, the carrier OSS 34 may provide operational system parameters, such as whether the network is meeting key metrics. The carrier OSS 34 may configure the frequencies used by the network, and allocate channels to the site where the base station 24 is located.

A host OSS 36 can be operated by a neutral host who is responsible for maintenance of the physical facility of the base station 24. The host OSS 36 can configure parameters related to the base station 24 that are common to all carriers. For example, the host OSS 36 may monitor the power supply and environmental conditions of the base station 24. The host OSS 36 may monitor security of the facility, such as whether a door at the facility is open. The host OSS 36 may also configure parameters related to the base station 24 that are specific to one or more carriers on behalf of those carriers.

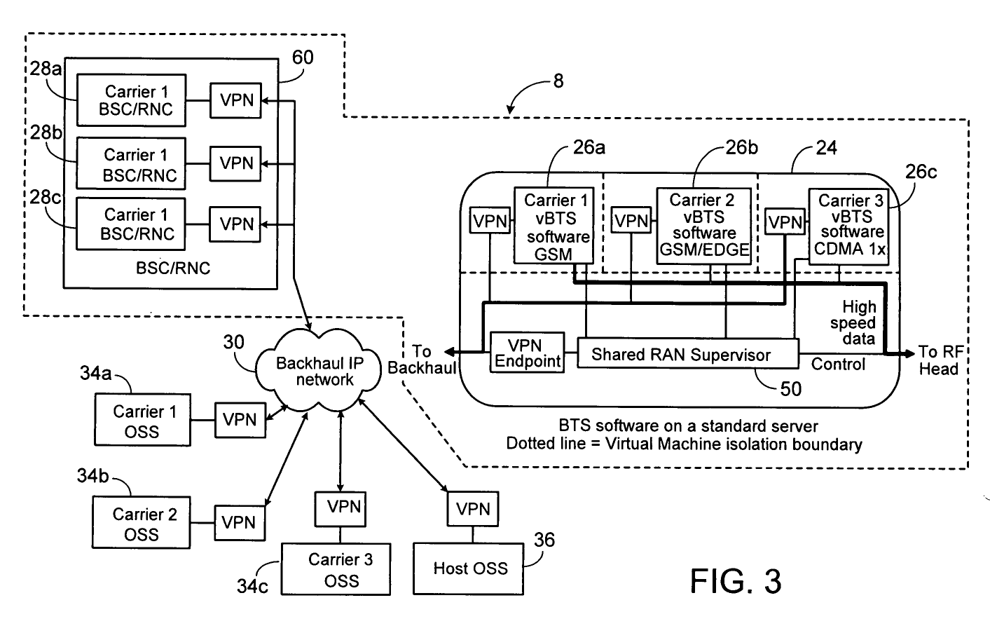

The carrier OSS 34 and host OSS 36 communicate with a supervisor (e.g., 50 in FIG. 3) that monitors hardware configurations and status of the base station 24. The supervisor 50 can reside at the base station 24 and can have software and hardware (e.g., sensors) components. The supervisor 50 can monitor the virtual base stations 26 to determine whether key parameters are met, and determine operational conditions such as frequencies of the network. The supervisor 50 can monitor hardware configurations by the various virtual base stations 26 to ensure compatibility and prevent hardware conflicts.

The virtual base stations 26, virtual BSC/RNC 28, carrier OSS 34, and host OSS 36 communicate with each other through a shared backhaul IP network 30. For example, as shown in FIG. 3, virtual private networks can be established so that each of the virtual base stations 26a, 26b, and 26c communicate with corresponding carrier OSS 34a, 34b, and 34c, and corresponding virtual BSC/RNC 28a, 28b, and 28c, respectively, through its virtual private network. This ensures that information private to one carrier cannot be accessed by other carriers.

Because the base station 24 is running in application space on a standard computing platform, IP connections to and from the base station 24 and the base station controller 60 are widely supported in the relevant computing hardware. In addition, because the Internet protocol permits each packet to be individually addressed and multiple applications to share the underlying medium, the bearer data (i.e., digitized voice data or digital files) and signaling required for each of the carriers' applications may be multiplexed on the same connection, allowing the carriers to share the backhaul connection 30 among different waveforms while continuing to preserve the isolation, security, and privacy of each carrier's network.

The base station controller 60, in turn, is communicatively coupled via links 90a, 90b and 90c, to each carrier's core network 92a, 92b, and 92c, respectively, allowing the carrier to provision service for its subscribers, switch calls, and provide supplementary services in the normal manner.

In some examples, the virtual base stations 26, virtual BSC/RNC 28, and operational support systems 34 and 36 can be implemented using hardware executing Anywave MultiRAN software, available from Vanu, Inc., Cambridge, Mass. The hardware for the shared active infrastructure 8 is standards agnostic, and each wireless standard can implemented in the Anywave software. For example, the Anywave GSM and CDMA systems can have the same hardware executing different software applications.

In some examples, the hardware used for the shared active infrastructure 8 can be similar to those described in U.S. Pat. No. 6,584,146, herein incorporated by reference. U.S. Pat. No. 6,584,146 describes the use of systems and methods including a wireless communications device having a collection of one or more processing elements, optionally forming a computer cluster, that together carry out the functions necessary to exchange information over a plurality of wireless communication links, wherein the communication links may employ different communication protocols, respectively. The systems and methods combine two techniques: the use of multiple flexible processing elements, and a design in which each of the elements can carry out any part of the processing performed by the device, including without limitation the physical, MAC, link, network, transport, and presentation layer processing.

Running two software applications simultaneously enables the support for two different standards on the same platform. The software can execute on off-the-shelf, industry-standard servers, which are used for all signal processing and higher layer functions. In some examples, the base station 24 can be Anywave Base Station, which is part of the Anywave MultiRAN software. The Anywave Base Station is available in both server and blade chassis configurations so that it scales more easily and cost-effectively than traditional base station architectures, while occupying a small footprint. The Anywave Base Station uses an open standard hardware approach that enables flexibility that translates into significant savings in both capital and operating expenses. Each server or blade supports multiple channels and/or multiple wireless standards simultaneously.

The Anywave MultiRAN uses native IP throughout for signaling, voice, data, and management. Techniques for backhauling wireless voice and data transmissions though an IP network is described in U.S. Patent Publication No. 2006-0007919, titled “Reducing cost of cellular backhaul”, filed Jun. 9, 2005, and U.S. Patent Publication No. 2005-0286536, titled “Reducing backhaul bandwidth”, filed Jun. 9, 2005, herein incorporated by reference. Any desired backhaul links can be used, e.g., T1/E1, Ethernet, satellite, microwave, digital subscriber loop, and cable modem. Because IP is used throughout the Anywave MultiRAN, cost-effective commercial switches, bridges and routers are available, as well as tools for network monitoring and maintenance. The burst data traffic can be efficiently multiplexed over IP, allowing for operating cost reductions in BTS backhaul. The IP based backhaul also gives the carriers the ability to choose the most cost effective means for backhaul, and simplifies the management of the overall network.

The Anywave MultiRAN can connect to the carrier's mobile switching center (MSC). Multiple switch interfaces are available that serve as gateway for the IP-based Anywave MultiRAN to legacy protocols such as SS7, GSM A or CDMA IOS. The Anywave MultiRAN includes interfaces that can connect directly to advanced soft-switches. SIP interface to standard VoIP switches can also be supported.

Virtualization can provide an abstraction layer that allows multiple virtual machines to execute in isolation from one another, side-by-side on the same physical machine. Since the Anywave system implements waveforms at the application layer and virtualization decouples the physical hardware from the software application, virtualization allows the creation of fully-configurable, isolated virtual machines, each with its own set of virtual hardware, on which to run an operating system and applications. In some implementations, virtualization tools, such as VMware (available from VMwave, Inc., Palo Alto, Calif.), Xen (available from Citrix Systems, Inc., Ft. Lauderdale), and VServer (available from Linux-VServer.org) can be used. When applied to Anywave, virtualization provides independent base stations running on a single server platform.

One advantage of virtualization of the radio access network is the ability to provide independent management control to each carrier in a shared network. This enables each carrier to optimize network parameters and assign frequencies and power limits independently. The virtualization software provides a level of protection and security between the virtual RANs, so one carrier cannot affect the parameters or performance of another. This solution provides the cost savings from sharing while maintaining concurrently the ability for carriers to competitively differentiate their networks by evolving.

Using virtualization in a shared environment can be complicated because although computing resources are isolated from one another, the underlying hardware, including the input and output devices and peripheral devices, to the extent they are shared, are not isolated. While it may be possible to run multiple sets of input and output devices in parallel, the duplicated costs associated with each would undermine the cost savings that would otherwise be attainable by employing a shared infrastructure.

The shared active infrastructure 8 shares resources while preventing contention for the resources or “collisions” (incompatible configurations) of those resources. In some implementations, the responsibility for preventing contention is shared among a trusted party and software tools. The software tools may include two categories. One category of tools are used by the carrier to manage its network, which may be constrained with respect to the options presented to the carrier in order to prevent that carrier from initiating unwanted configurations or information queries of the system. Another category of tools may be used to check proposed configurations to identify and prevent improper configurations and queries prior to their being put into effect by the system.

The trusted party, referred to as a “host”, maintains physical security of the system. Because the physical configurations (e.g., opening or closing of a security door, turning on or off of a power switch) may not be controlled via software, maintenance of physical security is necessary to prevent parties from intentionally or unintentionally altering the physical configuration of the system in a manner that is incompatible with sharing the system and maintaining the degree of isolation of each of the carriers from the others upon which the carriers have agreed. The host may be a cellular carrier who builds the network to meet its own needs and then leases space to other carriers. The host can be a third party, such as an outsourced vendor or a tower company.

Mobile stations 10 communicate with the base station 24 via different frequencies that may be licensed to different carriers. For example, in the United States, the frequencies can be personal communication service (PCS) frequencies denoted as the E, F and C blocks. In some examples, mobile stations 10c-1 and 10c-2 may communicate with the virtual base station 26c using different and incompatible communication standards that are both supported by the virtual base station 26c.

Signals from the mobile stations 10 are sent to the virtual base station 26 through antennas 14, a duplexer 15, a multi-carrier power amplifier (MCPA) 16, an analog connection 18, a wideband radio frequency head 20 (also called RF front end or RF head), and a digital interface 22. Signals from the virtual base station 26 are sent to the mobile stations 10 in reverse paths.

In some examples, the RF head 20 performs RF up/down conversion, analog to digital and digital to analog conversions, and digital channel filtering to provide multiple digital base band sample streams to the processing platform. The RF head 20 can simultaneously operate on, e.g., GSM, AMPS, CDMA, EDGE, UMTS, WiMAX, LTE, and WCDMA, and other technologies. The duplexer 15 is a filter that receives the antenna signals and separates the high-power transmit signals from the receive signals. The duplexer 15 may include a receive filter for a diversity receive antenna. The multi-carrier power amplifier 16 receives the low-power RF transmit signals from the RF head 20 and boosts it by as much as, e.g., 60 dB. The power amplifier 16 is designed to support simultaneous amplification of multiple waveforms within, e.g., a 25 MHz bandwidth.

The digital interface 22 transmits bearer traffic (which may include, e.g., digitized voice data and digital files) as well as control information, such as information for controlling the RF head 20, the power amplifiers 16, and the antennas 14. The digital interface 22 can use a fiber optic link or a gigabit Ethernet link.

A feature of the shared active infrastructure 8 is that it provides the cost benefits of shared active infrastructure for radio access networks while preserving independent RAN control for each carrier. For example, multiple carriers can select and upgrade cellular standards, control base station parameters, and add and/or modify services. Each carrier can do this without coordinating with the other carriers sharing the shared active infrastructure 8.

Many hardware resources are shared among different carriers. For example, active RF devices, such as the antennas 14, duplexer 15, power amplifiers 16, and radio frequency front end 20 are shared among the carriers. Hardware resources in the processing platform 25 are also shared among the carriers. As described below, the base station applications 26 are virtual applications that are executed on a shared hardware platform using virtualization. The virtualization platform can be implemented using a single software operating system executing on a shared hardware platform. Hardware such as processors, memory, and mass storage devices can be shared. Sharing of the hardware reduces the costs of each individual carrier. Similarly, the BSC/RNCs 28 may also be virtual applications that are executed on a shared hardware platform using virtualization.

The backhaul network can be, e.g., a leased T1 line, microwave, satellite, high speed Internet, or other IP based network.

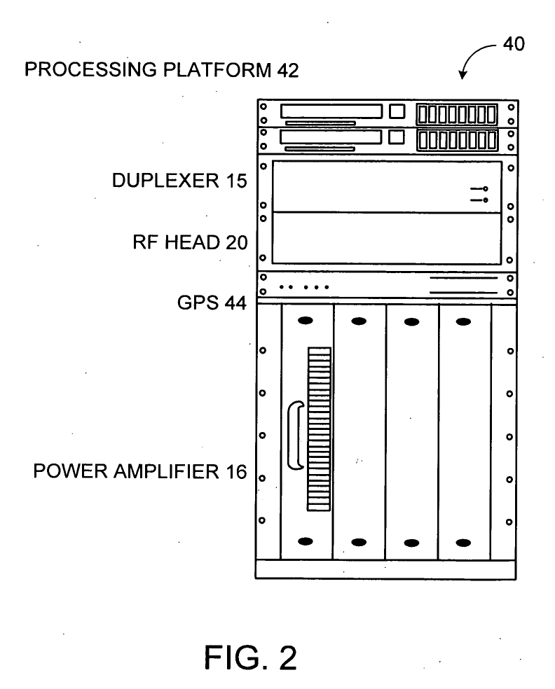

Referring to FIG. 2, the base station 24 can be implemented using, for example, a system 40 that includes a processing platform 42 that implements software radios and runs software waveforms on top of a standard operating system, e.g., Linux. The processing platform 42 can include one or more processing units, either embedded, rack mount, or blade. The processing platform 42 can support various applications that implement communication standards, e.g., GSM, AMPS, CDMA, EDGE, LTE, WiMAX and/or WCDMA. The processing platform 42 can be easily upgraded and re-configured to implement future communication standards.

The system 40 includes a duplexer 15, an RF head 20, a GPS frequency reference 44, and a multi-carrier power amplifier 16. The GPS 44 provides a highly accurate timing reference to the RF head 20. Both 10 MHz and 1 pulse-per-second references are used by a base station to achieve the required frequency accuracy and synchronize itself with other base stations. Because many of the hardware resources are shared, the base station 24 can have a small size (compared to a base station that does not use virtualization to share resources).

Referring to FIG. 3, the base station 24 uses virtual machine technology to implement multiple instances of software radio virtual base stations 26 that can be executed simultaneously. Each instance of the virtual base station 26 can be easily updated or re-configured. The base station 24 and associated high speed signal processing can be implemented as portable application-level software executing on a standard processor (e.g., Intel x86) and a standard operating system (e.g., Linux).

Virtual machine technology ensures that each virtual base station 26 has its own guaranteed allocation of processor capacity, memory, and input/output bandwidth. Each running virtual base station 26 can support a communications standard that is independent of the communications standards implemented by other virtual base stations 26. Different virtual base stations 26 may implement the same communications standard. For example, multiple GSM carriers may share the base station 24, each using a separate virtual base station 26.

Components of the virtual base station 26 that implement the standards or are carrier-specific are encapsulated inside the software applications and related configurations, which are isolated from each other by virtualization techniques. Different virtual base stations 26 can offer different services, can be configured differently, and can be upgraded independently. In FIG. 1B, the dashed lines in the base station 24 shows the isolation boundary of the virtual base stations 26.

The independent virtual base stations 26 share a common RF head 20, amplifiers 16, a duplexer 15, and antennas 14. Different virtual base stations 26 may have different hardware configuration requirements. The supervisor 50 intercepts configuration requests sent by a virtual base station 26 to a radio subsystem and assures that each virtual base station 26 uses only the resources it is allowed. For example, each carrier has its own spectrum allocation. The supervisor 50 only permits a virtual base station 26 to tune its radio head channels to frequencies within that carrier's allocation.

The base station controller 60 controls the base station 24. Multiple instances of virtual BSC/RNCs 28a, 28b, and 28c are executed on the base station controller 60 using virtualization technology. Each of the virtual base stations 26a, 26b, and 26c can be controlled remotely by the corresponding BSC/RNC 28a, 28b, and 28c, respectively.

The independent virtual base stations 26 share a common backhaul link 30 to the base station/radio network controller 28. The communications between the virtual base stations 26 and the base station/radio network controller 28 can be based on, e.g., Internet Protocol that enables multiplexing together the separate data flows for the virtual base stations 26, no matter what backhaul 30 is used (wired, microwave, optical, satellite, etc.). Virtual private network technology isolates the carriers' data flows from each other, assuring that each carrier's virtual base station 26 only communicates with that carriers' base station/radio network controller 28 and core network components. Using virtual private networks allows commercial or public IP networks to be used for the backhaul link 30.

The base station controller 60 can include software executing on standard server platforms, similar to the base stations 24. In some examples, one or more servers are fully dedicated to a particular carrier's base station controller (or radio network controller), while in other cases servers are shared among multiple carriers' base station controllers. Virtual machine technology is used to isolate the resources for each carrier when servers are shared. In some examples, the base station controller 60 can be implemented using a blade server chassis, with each blade dedicated to a carrier. In the above examples, each carrier has independent control over the configuration and operation of its base station controller(s), radio network controller(s), and other radio access network components.

In some implementations, different carrier OSSs 34a, 34b, and 34c can be located at different locations, for example, at each carrier's business offices. Each carrier controls its resources in the shared active infrastructure 8 (e.g., virtual base station 26, BSC/RNC 28, and transcoding and rate adoption unit (TRAU), etc.) in a manner that is similar to controlling the same resources in a radio access network built for that carrier's exclusive use. The carrier can upgrade and reconfigure its resources without coordinating with the other carriers sharing the hardware resources of the shared active infrastructure 8. Each carrier's resources communicate with the carrier's other resources and the core network over dedicated, private communications links. Each carrier has a virtual radio access network that is one of multiple virtual radio access networks operated by multiple carriers that share much of the resources of the shared active infrastructure 8.

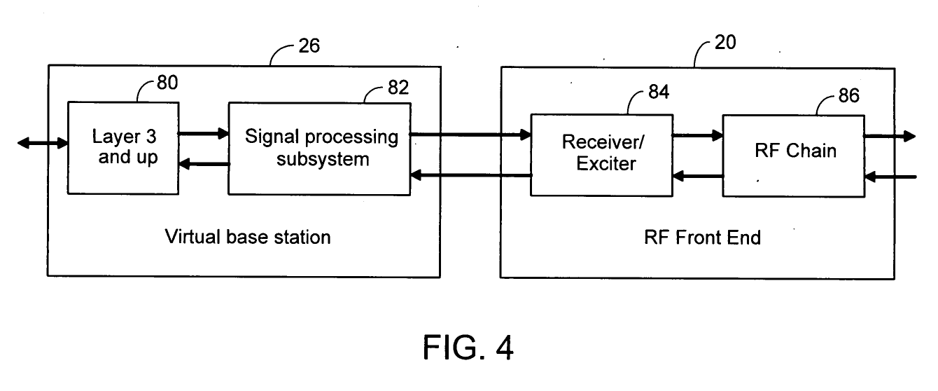

Referring to FIG. 4, each virtual base station 26 includes a component 80 for processing functions related to layer 3 (network layer) and higher. The layers here refer to the layers of the Open Systems Interconnection Basic Reference Model. A signal processing subsystem 82 provides functions such as equalization, despreading, demodulation, modulation and error correction. The signal processing subsystem 82 communicates with an RF front end 20. In some implementations, the component 80 and the signal processing subsystem 82 are both implemented in software.

The RF front end 20 performs RF up/down conversion, digitization, and digital channel filtering to provide multiple digital base band sample streams to the signal processing subsystem 82. The RF front end 20 can simultaneously operate on GSM, CDMA, and other technologies. The RF front end 20 includes a receiver/exciter that performs RF up conversion, RF down conversion, digital-to-analog conversion, analog-to-digital conversion, and digital channel filtering. An RF chain 86 performs power amplification on transmit, diversity filtering on reception, and includes a duplexer to separate the high-power transmissions from the weaker received signals. The RF front end 20 is a flexible multi-carrier device that exchanges a number of digitized carriers with the processing server, multiplexed over one or a few high-speed digital links. For example, the links can be implemented as packetized gigabit Ethernet.

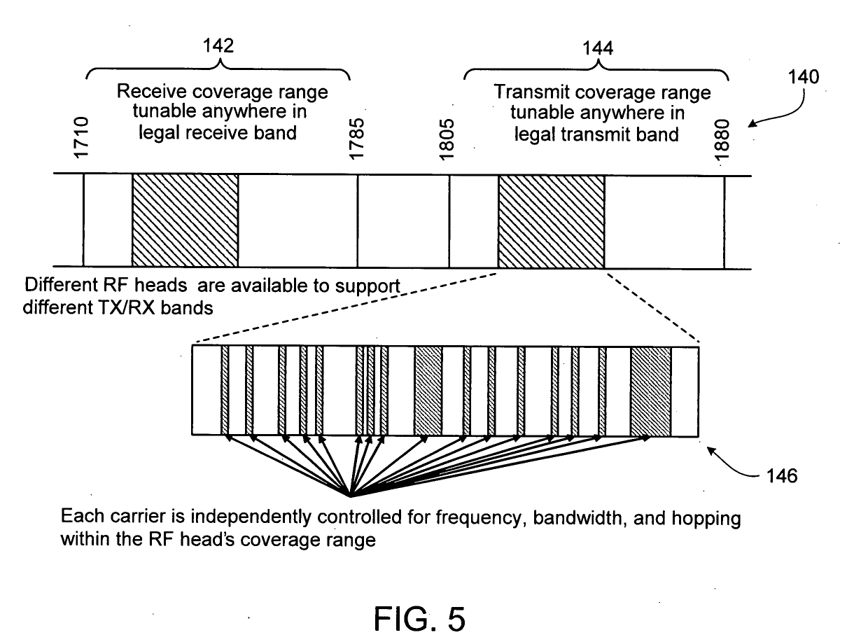

Referring to FIG. 5, each carrier is permitted to use one or more blocks of the wireless spectrum associated with the carriers. The operator, through the supervisor (e.g., 50 in FIG. 3), controls what frequency the carrier is tuned to within the overall band covered by the RF head. The operator controls what bandwidth the carrier occupies, and controls certain transmit and receive filter settings (digital taps) to assure the filtering applied is appropriate for the carrier's modulation scheme.

Different RF heads can support different transmit and receive bands 140. In the example shown in FIG. 5, the receive coverage range is tunable anywhere in the receive band 142 from 1710 to 1785 MHz, and the transmit range is tunable anywhere in the transmit band 144 of 1805 to 1880 MHz. Each carrier is independently controlled for frequency, bandwidth, and hopping within the RF head's coverage range 146.

Referring to FIG. 3, the shared active infrastructure 8 uses virtualization technology to implement virtual base stations 26 and virtual BSC/RNC 28, etc. The software components supporting virtual base stations 26 and virtual BSC/RNC 28 can be installed and supported by the host. In some examples, the host is responsible for hardware acquisition, maintenance and upgrades. The role of the host is to keep the base station hardware and backhaul network functioning properly so the cellular carriers sharing it can provide service. Hardware alarms can be handled by the host organization's OSS and are only distributed to the carriers sharing the radio access network for informational purposes.

In support of this role, the host configures and monitors the supervisor software applications on all shared equipment. The host ensures that required updates are applied to the operating system and supervisor software, and co-ordinates maintenance with the cellular carriers.

The host sets resource allocation policy and provisioning for the shared infrastructure. For example, the host controls the spectrum allocation table that limits the frequencies where each carrier's virtual base station 26 may operate at each site. The host specifies the proportion of base station capacity that is available to each carrier. Resource allocations are described in a node policy file that the host installs on each shared base station. The node policy file is used by the supervisor 50 to verify that resources requested by each virtual base station 26 conform to the resource allocation policy.

Below is a description of the functions of the supervisor 50. The shared active infrastructure 8 includes nodes that each executes a set of software components that are part of the supervisor 50. In general, the supervisor 50 is responsible for ensuring that each individual virtual base station 26 does not perform any operation, especially regarding shared hardware resources, that adversely affects any other virtual base station 26.

The shared active infrastructure 8 can have one or more nodes, and each node includes one or more virtual base stations 26. A node refers to the supervisor 50 and the virtual base stations and related shared hardware under the supervision of such supervisor. Several nodes may reside at the same location. A node may also span several locations.

In some implementations, the shared active infrastructure node is constructed using a virtualization approach that permits base station software applications to be executed inside a virtual machine without any modification, relying upon the virtualization infrastructure to intercept, examine, and/or modify the operations performed by a virtual base station 26 that may affect other virtual base stations 26. This approach has the advantage that the base station software can be the same as that used in non-shared (non-virtualized) systems, thus providing economies of scale and a higher degree of confidence that the software will function correctly. Furthermore, the virtualization infrastructure serves to constrain the behavior of the virtual base station 26, even if the base station software may not be configured properly and may result in conflicts among different virtual base stations 26 if not for the constraints by the virtualization infrastructure.

In some implementations, an approach called “paravirtualization” is used. Paravirtualization is the technique of assisting virtualization by adding a small number of virtualization-specific modifications to a software application. For example, in a fully virtualized system an application conducts input/output operations by executing the same instructions it would use if not running in a virtualized environment, which would be intercepted and emulated by the virtualization infrastructure. By comparison, a paravirtualized version of the same application would conduct input/output by issuing a special function call (often called a hypercall) into the virtualization infrastructure (the hypervisor).

At an abstract level, paravirtualization takes advantage of explicit modification of those operations that would have to be detected and emulated in a fully virtualized system. However, a paravirtualized system may be constructed in a manner such that overall system safety, i.e., isolation of one virtual environment from another, is ensured even when an unmodified operating system or application (one that has not been modified to use paravirtualized functions) is executed in the virtual environment. In such cases the unmodified entity may not function correctly, but cannot adversely affect other virtual environments. For example, an application in such a paravirtualized environment that fails to use the appropriate hypercall to conduct input/output will not function correctly, but is prevented from adversely affecting other virtual machines.

In the context of base station software, paravirtualization is applied by modifying the base station functions that normally interact directly with shared resources, e.g., RF components, so that instead they communicate with a broker, e.g., a supervisor agent, which is a part of the supervisor software, that mediates access to the components. Mediation of requests for use of shared resources are done according to some policy, which can be either a global policy encoded directly in the supervisor software 50, or an external policy communicated to the supervisor software 50 in some manner e.g., by configuration file. For example, the supervisor agent may mediate requests for shared resources on a first-come, first-served, preferential priority, or other dynamic basis.

The mediation of requests for use of shared resources is one of the functions of the supervisor 50, specifically the supervisor agent. Each virtual base station 26 communicates with the supervisor agent using a mechanism appropriate to the particular type of virtualization used by the shared active infrastructure node, such as a local network interface or other types of inter-process communication. In some examples, the interface between the base station application 26 and the supervisor agent is encapsulated in a generic application programming interface (API) that can be used to access certain resources in both shared and traditional non-shared environments. This way, the base station application does not need to be modified when running in a virtual machine. Instead, the virtual machine provides a different library implementation of the generic API.

For example, a base station function that accesses RF resources can be used to generate a new digital channel corresponding to a GSM carrier with a specific channel number, e.g., an absolute radio frequency channel number (ARFCN). In a system where the supervisor 50 is not used, this function can be implemented by a library called by the communications application that sends a request directly to an RF head requesting that the RF head generate a new digital channel. By comparison, in an SAI node, an alternative library sends a corresponding request to the supervisor agent, which issues the request to the RF head if the request complies with the configuration policy. In the alternative, in an SAI node, it would also be possible to route requests from the carrier OSS 34 through the supervisor 50. The supervisor 50 would then issue the request to the virtual BTS if the request complies with the configuration policy.

The node configuration policy specifies the radio resources (frequency bands, transmit power settings, etc.) available to each carrier, and the capacity that each carrier has licensed for each wireless standard available on the shared active infrastructure. Capacity may be specified in terms of number of radio channels, which is used by the supervisor 50 to limit the number of channels generated by the carrier and also to determine the appropriate amount of computational resources (CPU time, memory usage, I/O bandwidth) available to each virtual base station. A generic configuration policy can be applied to heterogeneous SAI nodes that may provide different levels of computing resources. The supervisor 50 translates generic capacity limits into node-specific limits.

One aspect of the node configuration policy is that each carrier is assigned a range of frequencies for use that can be subsequently used by base station applications to allocate individual radio channels. The individual channel assignments are not part of the node configuration policy, but rather are specified in the base station configuration files that are managed by each carrier. This permits a single node configuration policy to be used across a number of SAI nodes, rather than requiring a node configuration policy that contains coordinated channel assignments for all carriers using a particular node. In some cases a single policy file may be suitable for a uniform SAI network, where a fixed set of carriers use the same frequency bands across the entire network. However, larger, more complex networks may require multiple node configuration policies to reflect different combinations of carriers and/or different frequency bands in use in different parts of the network.

Another function of the supervisor 50 is monitoring hardware alarms and reporting them to necessary parties, which may include both local virtual base station applications and remote OA&M (operations, administration, and maintenance) systems. Many hardware alarms need to be reported to both the entity (e.g., the host) that is responsibly for operating and maintaining the hardware, and also to carriers using the SAI network who need to be aware of equipment failures in order to effectively operate their network and address customer inquiries

Another capability that may be provided by the supervisor 50 is dynamic provisioning of computational resources. In some cases an SAI node may be over-provisioned by the node configuration policy, such that the total number of computational resources that would be required to provide each carrier with the assigned capacity is greater than the actual capacity of the SAI node. In such a deployment scenario each virtual base station 26 is initially granted a base level of resources necessary to provide common or broadcast channels. The supervisor 50 requests additional resources as required to support traffic (voice and data) channels allocated dynamically to mobile stations 10. This form of statistical multiplexing may be used when the level of utilization of each carrier is typically less than 100%, e.g., if the carriers can be provided with a lower cost service (e.g., on an actual usage basis rather than provisioned capacity) in return for being willing to suffer from higher call blocking rates in rare occasions when all the virtual base stations 26 on a given SAI node attempt to acquire a high level of resources.

In some implementations, a business model for the shared active infrastructure assumes the host organization makes the capital investment in the shared active infrastructure 8 hardware. The host earns a return on capital from lease payments made by the carriers sharing the shared active infrastructure 8. Even factoring in lease payments, the carriers achieve substantial operational expense savings due to the benefits of sharing, while their capital expenditure requirements can drop significantly.

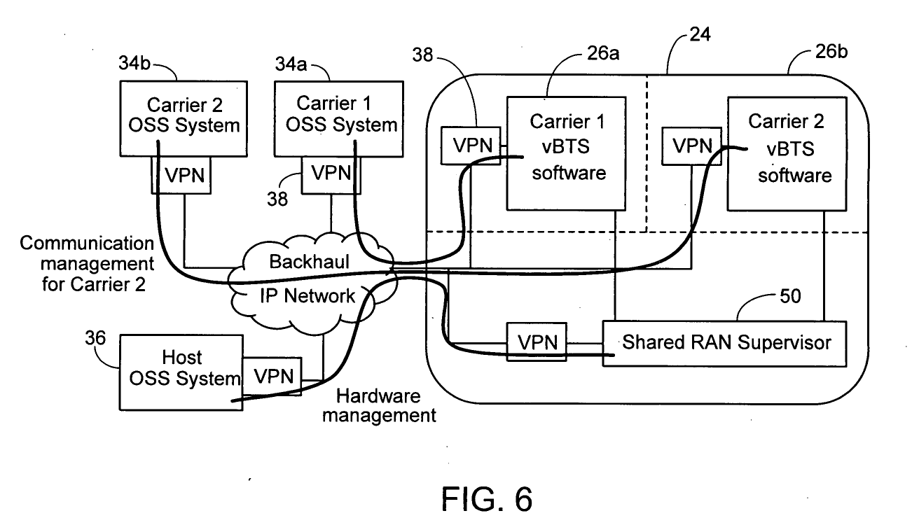

Referring to FIG. 6, each virtual base station 26 generates telemetry and alarms and is controlled just as it would be in a network dedicated to an individual carrier. The alarms flow through the carrier's dedicated VPN 38 to the carrier's network operations center or OSS system 34. From the perspective of the carrier, management of most communications issues is unaffected by sharing a shared active infrastructure 8 with other carriers since the virtual private network 38 provides security to the transmission of data. The communications issues may include, e.g., call handling analysis, customer quality of service management, load monitoring, and load prediction.

A difference between a shared active infrastructure and a dedicated network is in the handling of issues related to the underlying hardware, such as over-temperature alarms, power supply fluctuations, or cabling failures. These situations are handled by the supervisor 50 that interacts over the host organization's VPN with the host's network operations center or OSS system. The host exchanges information with the carriers as required by the hardware situation. This is consistent with the host organization's responsibility to install, manage, and maintain the underlying hardware systems.

The supervisor 50 can monitor various parameters of the virtual base stations 26, such as traffic statistics, and changes in the traffic statistics. The supervisor 50 also gathers information about the underlying hardware shared by various virtual base stations 26. The supervisor 50 can generate reports based on the gathered information and send the reports to the appropriate parties.

A feature of the supervisor 50 is that it can determine what reports should be sent to which party or parties. There are aspects of the base station 24 that are shared and can be reported to all carriers having a presence at the base station 24. For example, reports on how much capacity of the base station 24 is used by all virtual base stations 26 may be relevant to all carriers. There are aspects of the base station 24 that are private and should be reported only to the relevant carriers. For example, reports on performance statistics related to the operation of the virtual base station 26a should be sent to the corresponding carrier OSS 34a. Reports on how much of the capacity allocated to the virtual base station 26b is being utilized should be sent to the corresponding carrier OSS 34b, and so forth. In some examples, there may be resources that are allocated to multiple carriers, so reports on conditions of the resources can be sent to the relevant carrier OSS's 34.

There are aspects of the base station 24 that are relevant to the host maintaining the physical facility, and can be reported to the host. For example, an alarm indicating that a door to the site is open can be reported to the host.

In some implementations, carriers can opt-in and request receipt of certain administrative reports, such as alarms indicating that a door to the site is open. In this case, the alarm will be reported to the host and the carriers who have opted-in to receive the reports.

There are a few instances where the sharing of resources of the shared active infrastructure 8 limits the flexibility of carriers to manage communications issues. For example, if there is a single shared antenna, the carriers have to agree on what downtilt to select or invest in separate hardware resources. Such resource conflicts are detected and prevented by the supervisor 50. Resolution of the conflicts can be achieved through agreement between the carriers rather than a technical solution imposed by the supervisor 50.

Each carrier can halt, modify, and restart its software resources (virtual base station 26, virtual BSC/RNC 28, transcoding and rate adoption unit (TRAU), etc.) in the shared active infrastructure 8 without affecting the ongoing operation of other carrier's resources sharing the shared active infrastructure 8. A carrier who chooses to upgrade to a new communications standard or modify the services or features it offers can do so on its own schedule. Both the carrier and the host organization perform qualification and approval on new software. The carrier qualification process handles communications issues, while the host organization qualification process handles issues that could affect the shared platform (e.g., security).

Whenever an upgrade or modification is performed, there is a risk of problems such as a configuration error that makes the system unstable. The resource isolation provided by the virtual machine technology and the monitoring by the supervisor 50 ensures that problems in one carrier's virtual base station 26 do not affect the behavior of another carrier's virtual base station 26.

There are limits on the processor capacity and transmit power of the base station 24. The underlying hardware resources are partitioned among the carriers sharing the base station 24. Any desired partitioning whether equal or unequal may be specified in the supervisor software configuration. A carrier who wishes to modify or upgrade its virtual base station 26 or other software resources in a way that exceeds its current resource allocation may make arrangements either to increase its allocation or to have the host organization improve the hardware capabilities at that site.

The shared active infrastructure 8 enables sharing the costs of cellular network infrastructure while preserving carrier independence. Each carrier has its own virtual radio access network executing on top of the shared active infrastructure 8. The carrier configures, controls, and upgrades its virtual radio access network independently of the choices made by the other carriers sharing the shared active infrastructure 8. Through the underlying software radio technology of the base station sub-system, the carriers can run different communication standards at the same time on the shared cost-effective base station hardware platform. Virtual machine technology in the base station 24 and virtual private network technology in the backhaul isolate the carriers' virtual radio access networks from each other.

The shared active infrastructure 8 enables sharing among carriers who have competitive differentiation in their service offerings or upgrade paths. The shared active infrastructure 8 offers the potential to increase coverage in underserved rural areas and reduce footprint in congested urban areas, while preserving full and open competition to benefit all users of cellular services.

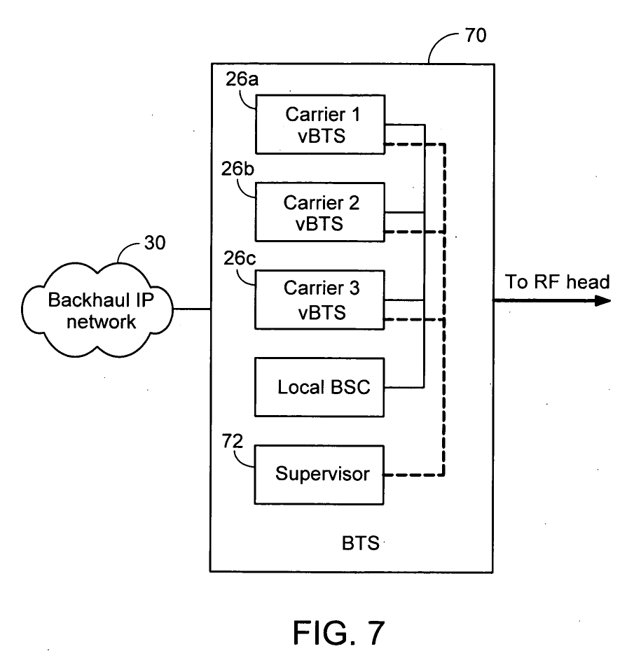

Referring to FIG. 7, in some implementations, the active infrastructure 8 can have a flat network architecture using a local base station controller 72 (or radio network controller) at the site along virtual base stations 26a, 26b, and 26c, all executing at a server 70. Local calls from one virtual base station to another virtual base station can be routed by the local base station controller 72. The value of the flat architecture combined with the IP backhaul 30 is that the bearer traffic for local mobile-to-mobile calls does not have to be transported over the backhaul 30, only the lower bandwidth signaling is transported back to the central switch.

Estimates for some rural villages indicate that a large portion of the calls originating in the villages are local, so this may correspond to large savings in the backhaul transport costs using this architecture. The bandwidth savings from a flat architecture may also make satellite backhaul a cost effective option for remote areas, given the dramatic reduction in backhaul bandwidth requirements.

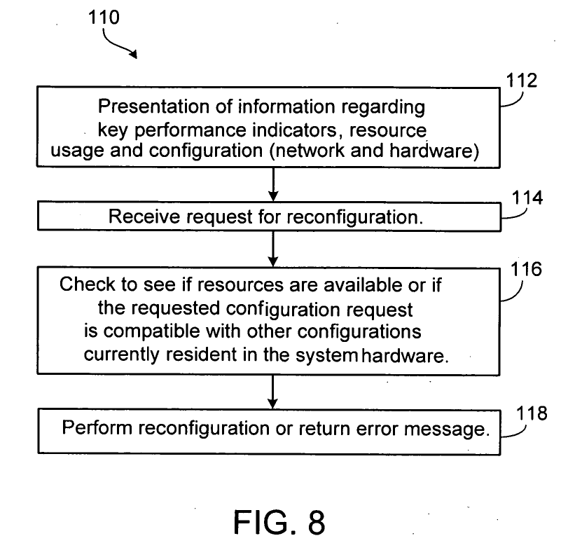

FIG. 8 is a flow diagram of an example process 110 by which management by a carrier of its virtual base station 26 may be achieved. The process 110 begins with communication to the carrier information regarding the current state of its application and the platform (112). The information can be provided by, e.g., the virtual base station 26 and the supervisor 50. The information can include configuration information, for example, the number of channels allocated to each of the communications protocols supported by the carrier. The information can be presented through an element management system. The information can include resource availability information such as unused computing capacity, power amplification, and/or RF transmission or reception resources available to the carrier. The information available to the carrier can include key performance indicators, such as call blocking and other system usage and performance data.

Based on the information and assuming there is sufficient additional computing, RF and power amplification capacity, requests can be received from the carrier for reconfiguration of the virtual base station to, for example, increase the number of channels the virtual base station supports on behalf of the carrier (114).

During the reconfiguration, the carrier's proposed parameters for the reconfiguration is checked to ensure that the required resources are available, and that the proposed parameters do not conflict with configurations employed by other carriers (116). In some examples, the checks can be performed via software applications administered by the host. The checks can also be performed manually by the host.

Following confirmation that the reconfiguration request does not conflict with other carriers and that adequate resources are available to support the request, the requested reconfiguration is implemented (118). If a conflict is detected, an error message is returned.

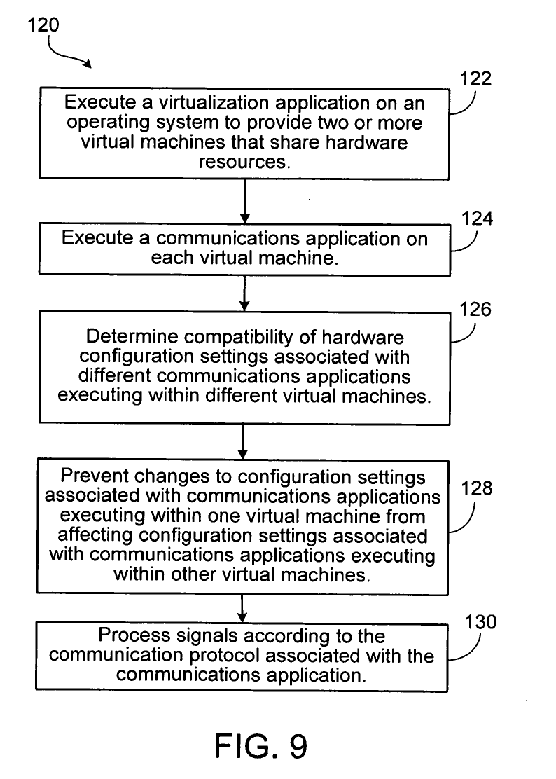

FIG. 9 is a flow diagram of an example process 120 for executing a virtual base station. A virtualization application is executed on an operating system to provide two or more virtual machines that share hardware resources (122). The hardware resources can include memory and at least one data processor. Each virtual machine can be configured independently of other virtual machines, and the virtualization application provides a security mechanism to enable each virtual machine to have independent control of access to data and configuration settings that are private to the virtual machine. A communications application is executed on each virtual machine to process signals received from and transmitted to wireless devices according to a communications protocol (124).

Compatibility of hardware configuration settings associated with different communications applications, executing within different virtual machines, is determined (126). Changes to configuration settings associated with communications applications, executing within one virtual machine are prevented from affecting configuration settings associated with communications applications executing within other virtual machines (128). For example, a first communications application executing on a first virtual machine is prevented from accessing a hardware resource if accessing the hardware resource by the first communications application results in a conflict with other communications applications executing on other virtual machines.

Signals are processed according to the communications protocol associated with the communications application (130). For example, the communications protocol can be GSM, AMPS, CDMA, EDGE, UMTS, WiMAX, LTE, and WCDMA.

A number of implementations and examples have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated.

For example, while a cellular receiver wireless communication system is described above, other communication systems can also use the shared active infrastructure. The backhaul connection 26 can be based on standards other than the Internet Protocol. The shared active infrastructure 8 can support communications protocols not described above. A radio base station controller 28 can control base stations 26 at multiple locations. The number of virtual base stations, virtual base station controllers, and carriers can be different from those described above. Components may be added to, or removed from, the systems described above. Accordingly, other implementations are within the scope of the following claims.

What is claimed is:

1. A method comprising:
executing two or more communications applications on a shared processing platform, the shared processing platform having shared hardware resources including memory and at least one data processor to process signals received from and transmitted to wireless devices according to a communications protocol;
providing a security mechanism to enable each communications application to have independent control of access to data and configuration settings that are private to the communications application; and
determining compatibility of and mediating conflicts between hardware configuration settings associated with different communications applications.

2. The method of claim 1, comprising executing a virtualization application to provide two or more virtual machines in which the two or more communications applications execute, the virtualization application providing the security mechanism to enable independent control of access to data and configuration settings by the communications applications executing in the two or more virtual machines.

3. The method of claim 2, comprising connecting a local call from a first wireless device to a second wireless device through at least one virtual machine without routing the call to a central switching facility that processes calls in addition to calls processed by the virtual machines.

4. The method of claim 3 in which connecting the call comprises
at a first virtual machine, processing a call from the first wireless device, routing the call to a second virtual machine, and
at the second virtual machine, connecting to the second wireless device to complete connection of the call.

5. The method of claim 2, comprising at each virtual machine, accessing the shared hardware resources to perform at least one of physical, link, network, transport, session, and presentation layer processing functions for communicating with the wireless devices according to one or more communications protocols.

6. The method of claim 2, comprising executing a virtual base station on each virtual machine.

7. The method of claim 6, comprising executing virtual base station controllers to control corresponding virtual base stations.

8. The method of claim 7, comprising transferring information between the virtual base station and the virtual base station controller through a virtual private network established over a backhaul link shared by more than one carrier.

9. The method of claim 2, comprising using the communications applications to access shared hardware resources and perform input/output operations in a manner that is the same as if the communications applications were not executing on the virtual machine.

10. The method of claim 2 in which executing two or more communications applications on the shared processing platform comprises executing paravirtualized versions of the two or more communications applications to access shared hardware resources and perform input/output operations by issuing function calls to a virtualization infrastructure in a manner that is different than if the communications applications were not executing on the virtual machines.

11. The method of claim 2, comprising processing signals at different virtual machines using different communications protocols.

12. The method of claim 1, comprising preventing changes to configuration settings associated with one communications application from affecting configuration settings associated with other communications applications.

13. The method of claim 1, comprising determining compatibility of and mediating conflicts between capacity utilization associated with different communications applications.

14. The method of claim 1, comprising executing a supervisor application to monitor configuration settings associated with the communications applications.

15. The method of claim 14, comprising selectively sending reports from the supervisor application to at least one of the carriers of the communications applications and a host who maintains hardware for supporting the operating system.

16. The method of claim 1, comprising sending a report from the supervisor application to a particular carrier or selected carriers that are less than all carriers.

17. The method of claim 1, comprising sending a report from the supervisor application to the host but not the carriers.

18. The method of claim 1, comprising preventing a first communications application executing on the shared processing platform from accessing a hardware resource if accessing the hardware resource by the first communications application results in a conflict with other communications applications executing on the shared processing platform.

19. The method of claim 1, comprising configuring two communications applications to use different frequency bands when communicating with the wireless devices.

20. The method of claim 1, comprising sharing at least one of a power amplifier, a wideband radio frequency front end, a duplexer and diversity filter and an antenna among different communications applications.

21. The method of claim 1, comprising connecting a local call from a first wireless device to a second wireless device through at least one communications application without routing the call to a central switching facility that processes calls in addition to calls processed by the communications applications.

22. The method of claim 21 in which connecting the call comprises
at a first communications application, processing a call from the first wireless device,
routing the call to a second communications application, and
at the second communications application, connecting to the second wireless device to complete connection of the call.

23. The method of claim 1, comprising receiving an instruction to reconfigure a first communications application executing on the shared processing platform, and determining whether executing the instruction to reconfigure the first communications application will generate a conflict with other communications applications executing on the shared processing platform or generate a conflict with capacity rights granted to a carrier executing the first communications application.

24. The method of claim 23 in which receiving an instruction to reconfigure the first communications application comprises receiving an instruction to modifying a number of channels allocated to the communications protocol associated with the first communications application.

25. The method of claim 1 in which executing a communications application comprises executing a communications application to process the signals received from and transmitted to wireless devices according to at least one of GSM, AMPS, CDMA, EDGE, UMTS, WiMAX, LTE, and WCDMA communications protocol.

26. The method of claim 1, comprising using the communications application to access shared hardware resources and perform input/output operations through a supervisor agent that mediates access to the shared hardware resources by the communications applications.

27. The method of claim 26, comprising using the supervisor agent to mediate a configuration request from a carrier operational support systems (OSS) to the communications application.

28. The method of claim 26, comprising using the supervisor agent to mediate requests for resources on a first-come, first-served, preferential priority, or other dynamic basis.

29. A system comprising:
a shared processing platform having hardware resources including memory and at least one data processor;
communications applications that are executed on the shared processing platform to process signals received from and transmitted to wireless devices according to a communications protocol; and
an operating system that supports execution of the communications applications and provides a security mechanism to enable each communications application to have independent control of access to data and configuration settings that are private to the communications application.

30. The system of claim 29 in which the operating system supports execution of a virtualization application to provide two or more virtual machines in which the two or more communications applications execute, the virtual machines sharing the hardware resources, the virtualization application providing the security mechanism to enable independent control of access to data and configuration settings by the communications applications executing in the two or more virtual machines.

31. The system of claim 30 further comprising a supervisor to determine whether executing an instruction to reconfigure a virtual machine will generate a conflict with other virtual machines.

32. The system of claim 30 in which two communications applications executing on different virtual machines use different frequency bands when communicating with the wireless devices.

33. The system of claim 30 in which two communications applications executing on different virtual machines process signals using different communications protocols.

34. The system of claim 30 in which the communications applications access the hardware resources and perform input/output operations in a manner that is the same as if the communications applications were not executing on the virtual machines.

35. The system of claim 30 in which the communications applications comprises paravirtualized versions of the communications applications that access the hardware resources and perform input/output operations by issuing function calls to a virtualization infrastructure in a manner that is different than if the communications applications were not executing on the virtual machines.

36. The system of claim 29, further comprising a supervisor to determine compatibility of hardware configuration settings associated with different communications applications.

37. The system of claim 36 in which the supervisor prevents changes to configuration settings associated with one communications application from affecting configuration settings associated with other communications applications.

38. The system of claim 36 in which the supervisor prevents a communications application from accessing a hardware resource if accessing the hardware resource by the first communications application results in a conflict with other communications applications.

39. The system of claim 36 in which the supervisor determines whether modifying a number of channels allocated to the communications protocol associated with a communications application will generate a conflict with other communications applications.

40. The system of claim 29, comprising at least one of a power amplifier, a wideband radio frequency front end, and an antenna that is shared among different virtual machines.

41. The system of claim 29 in which the operating system provides interfaces to allow the communications applications to access the shared hardware resources.

42. The system of claim 29 in which the communications applications are configured to route local calls from a first wireless device to a second wireless device without routing the call to a central switching facility that processes calls in addition to the calls processed by the communications applications.

43. The system of claim 29 in which the communications protocol comprises at least one of GSM, AMPS, CDMA, EDGE, UMTS, WiMAX, LTE, and WCDMA.

44. The system of claim 29 in which each communications application accesses the shared hardware resources to perform at least one of physical, link, network, transport, session, and presentation layer processing functions for communicating with the wireless devices according to one or more communications protocols.

45. The system of claim 29 in which the communications applications comprise virtual base stations.

46. The system of claim 45, comprising virtual base station controllers to control corresponding virtual base stations.

47. The system of claim 46 in which the virtual base station controllers are located at the same location as the virtual base stations and route local calls from a first wireless device to a second wireless device without routing the call to a central switching facility.

48. The system of claim 45, comprising a virtual private network endpoint of a virtual private network established over a backhaul link shared by more than one carrier, in which the virtual base station communicates with a virtual base station controller through the virtual private network.

49. The system of claim 29 in which the communications application access the hardware resources and perform input/output operations through a supervisor agent that mediates access to the shared hardware resources by the communications applications.

50. An apparatus comprising:
a shared processing platform for executing two or more communications applications, the shared processing platform having shared hardware resources including memory and at least one data processor to process signals received from and transmitted to wireless devices according to a communications protocol;
means for providing a security mechanism to enable each communications application to have independent control of access to data and configuration settings that are private to the communications application; and
means for determining compatibility of and mediating conflicts between hardware configuration settings associated with different communications applications.
